(19) United States
(12) Patent Application Publication
(10) Pub. No.: US 2015/0328963 A1
(43) Pub. Date: Nov. 19, 2015

(54) APPARATUS FOR ASSEMBLING WINDSHIELD GLASS AND COWL TOP COVER FOR VEHICLE

(71) Applicant: Kia Motors Corporation, Seoul (KR)

(72) Inventors: Sang Jin LEE, Seoul (KR); Nam Cheol KIM, Suwon-Si (KR); Seong Hwan RYU, Incheon (KR); Jeong Ho LEE, Suwon-Si (KR)

(73) Assignee: Kia Motors Corporation, Seoul (KR)

(21) Appl. No.: 14/563,766

(22) Filed: Dec. 8, 2014

(30) Foreign Application Priority Data
May 15, 2014 (KR) 10-2014-0058131

(51) Int. Cl. B60J 1/00; B60J 1/02; B62D 25/08

(52) U.S. Cl. CPC B60J 1/006; B62D 25/081; B60J 1/02

(57) ABSTRACT

An apparatus for assembling a windshield glass and a cowl top cover for a vehicle may include a strip disposed between the windshield glass and the cowl top cover, and a matching maintaining device disposed at bottom portions of the windshield glass and the cowl top cover, binding a lower end portion of the windshield glass and a stepped portion of the cowl top cover together, and allowing the windshield glass and the cowl top cover to float at the same time.

### CROSS-REFERENCE TO RELATED APPLICATION

The present application claims priority to Korean Patent Application No. 10-2014-0058131 filed May 15, 2014, the entire contents of which is incorporated herein for all purposes by this reference.

### BACKGROUND OF THE INVENTION

1. Field of the Invention

The present invention relates to an apparatus for assembling a windshield glass and a cowl top cover for a vehicle. More particularly, it relates to an apparatus for assembling a windshield glass and a cowl top cover for a vehicle, which may improve external appearance matching property between the windshield glass and the cowl top cover and reinforce rigidity.

2. Description of Related Art

In general, a cowl top panel is disposed at a portion which forms a boundary between an engine room and a driver seat, and forms a boundary between the engine room and a windshield glass, and a cowl top cover, which covers an upper portion of the cowl top panel, is matched with and coupled to the windshield glass.

The attached FIG. 1 is a cross-sectional view illustrating a coupling structure between a windshield glass and a cowl top cover in the related art.

As illustrated in FIG. 1, a windshield glass 10 and a cowl top cover 20 are matched and joined while having a strip 30 interposed therebetween.

In more detail, a lower end portion of the windshield glass 10 is matched and in close contact with a stepped portion 22 formed on an upper end portion of the cowl top cover 20, while having the strip 30 interposed between the windshield glass 10 and the cowl top cover 20.

In addition, a sealer 32 for airtightness and watertightness is applied between a back surface of the windshield glass 10 and an upper surface of the cowl top panel which is disposed below the cowl top cover 20.

When the windshield glass and the cowl top cover are matched as described above, an outer surface of the windshield glass and an outer surface of the cowl top cover need to horizontally match without having assembly tolerance in consideration of an aesthetic appearance.

However, a floating phenomenon occurs due to considering tolerance for the cowl top cover when manufactured and assembled, and tolerance for the windshield glass when manufactured and assembled, and a function of absorbing the tolerance is insufficient although the strip, which is placed between the windshield glass and the cowl top cover, is made of a material having elasticity, and as a result, there is a problem in that a stepped portion is formed between the windshield glass and the cowl top cover such that mutual matching property is not accurate, which causes a defect in an external appearance.

In particular, in a case in which the windshield glass floats inward and outward when the windshield glass is assembled, there is a problem in that the windshield glass and the cowl top cover do not form a straight line, and mutual matching property is more inaccurate, which causes a defect in an external appearance.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus for assembling a windshield glass and a cowl top cover for a vehicle in which a matching bracket, which couples the windshield glass and the cowl top cover, is added when the windshield glass and the cowl top cover are matched, such that the windshield glass and the cowl top cover float together by the matching bracket even though the windshield glass or the cowl top cover floats when the windshield glass and the cowl top cover are assembled, thereby preventing a stepped portion from being formed between the windshield glass and the cowl top cover, and allowing mutual matching to be accurately performed.

In one aspect, the present invention provides an apparatus for assembling a windshield glass and a cowl top cover for a vehicle, including a strip which is disposed between the windshield glass and the cowl top cover, and a matching maintaining means which is disposed at bottom portions of the windshield glass and the cowl top cover, binds a lower end portion of the windshield glass and a stepped portion of the cowl top cover together, and allows the windshield glass and the cowl top cover to float at the same time.

In a preferred embodiment, the matching maintaining means may include: a matching bracket which includes a body portion, an elastic plate which is formed integrally with a lower end at one side of the body portion, a locking hole which penetrates the elastic plate, and a fixed plate which is formed integrally with an upper end at one side of the body portion; a hook portion which is formed integrally with an end of the stepped portion of the cowl top cover, fitted between the fixed plate and the elastic plate, and locked and fastened to the locking hole of the elastic plate; and a welding member which is attached to outer surfaces of the body portion and the fixed plate, and joined to an inner surface of the windshield glass.

In another preferred embodiment, two or more rows of rigidity reinforcing ribs may be integrally formed on a back surface of the matching bracket.

Through the aforementioned technical solutions, the present invention provides the effects below.

Firstly, when the windshield glass and the cowl top cover are matched, the lower end portion of the windshield glass and the stepped portion of the cowl top cover are connected using the matching bracket, thereby preventing a stepped portion from being formed between the windshield glass and the cowl top cover, and allowing mutual matching to be accurately performed.

That is, even though one of the windshield glass and the cowl top cover floats, the windshield glass and the cowl top cover float together using the matching bracket, thereby preventing a stepped portion from being formed between the windshield glass and the cowl top cover, and allowing mutual matching to be accurately performed.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating a matching structure between a windshield glass and a cowl top cover in the related art.

FIG. 2 is a cross-sectional view illustrating a matching structure between a windshield glass and a cowl top cover according to an exemplary embodiment of the present invention.

FIG. 3A and FIG. 3B are perspective views illustrating a matching bracket structure between the windshield glass and the cowl top cover according to the exemplary embodiment of the present invention.

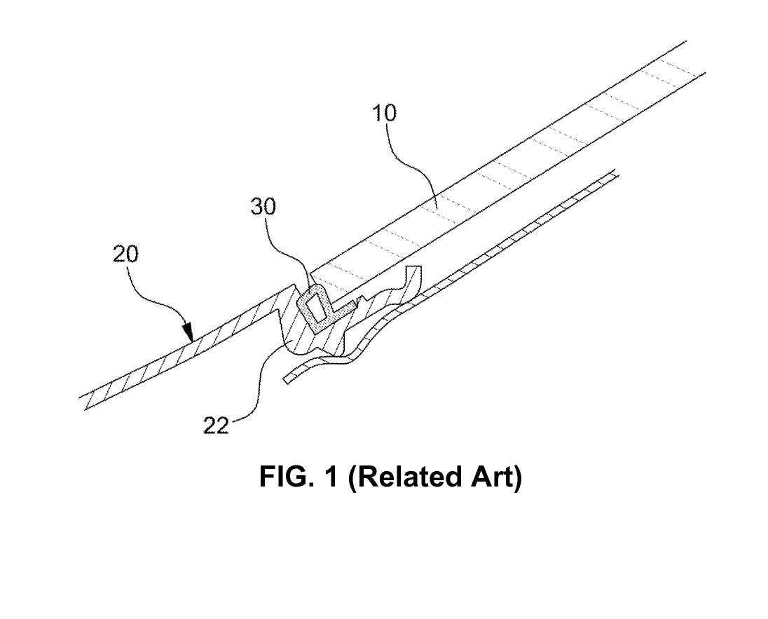

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

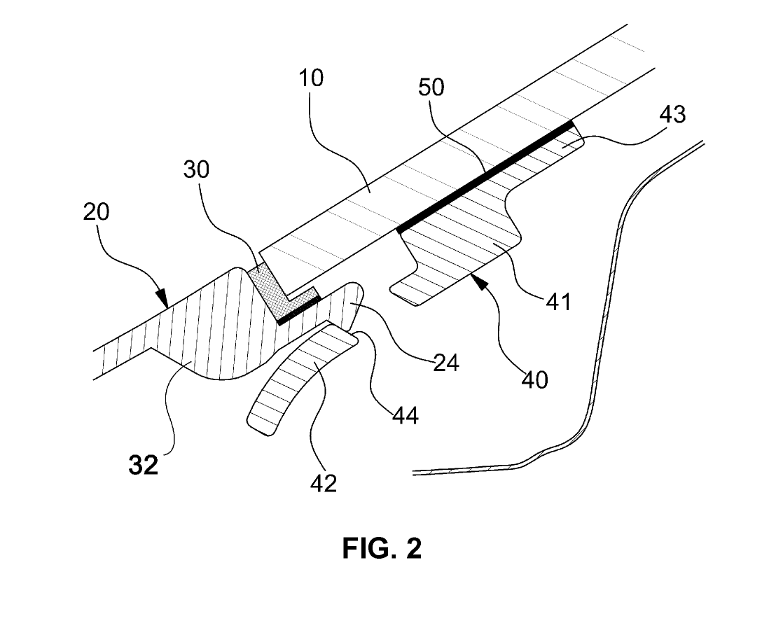

As described above, a cowl top panel is disposed at a portion which forms a boundary between an engine room and a driver seat, and forms a boundary between the engine room and a windshield glass, and as illustrated in FIG. 2, a cowl top cover 20, which covers an upper portion of the cowl top panel, is matched with a windshield glass 10, and exposed to the outside.

In more detail, a lower end portion of the windshield glass 10 and a stepped portion 32, which is formed on an upper end portion of the cowl top cover 20 and has an L-shaped cross section, are matched while having a strip 30 interposed therebetween for maintaining watertightness and airtightness.

In this case, when the windshield glass 10 is matched and assembled with the cowl top cover 20, the windshield glass floats upward due to considering tolerance when the windshield glass is manufactured and assembled, such that a stepped portion is formed between the windshield glass and the cowl top cover, and mutual matching property is inaccurate, which may cause a defect in an external appearance.

In order to solve the aforementioned problem, the main object of the present invention is that the lower end portion of the windshield glass 10 and the stepped portion 32 of the cowl top cover 20 are bound together in a state in which the windshield glass 10 and the cowl top cover 20 are matched while having the strip 30 interposed therebetween, and the windshield glass 10 and the cowl top cover 20 float together when one of the windshield glass and the cowl top cover floats (for example, when the windshield glass floats), thereby preventing a stepped portion from being formed between the windshield glass and the cowl top cover, and allowing the windshield glass and the cowl top cover to maintain an accurate matching state corresponding to designed assembly tolerance.

To this end, the present invention is characterized in that the lower end portion of the windshield glass 10 and the stepped portion 32 of the cowl top cover 20 are bound together using a separate matching maintaining means in a state in which the windshield glass 10 and the cowl top cover 20 are matched while having the strip 30 interposed therebetween, thereby allowing the windshield glass 10 and the cowl top cover 20 to float at the same time.

Here, the matching maintaining structure according to various embodiments of the present invention will be described below.

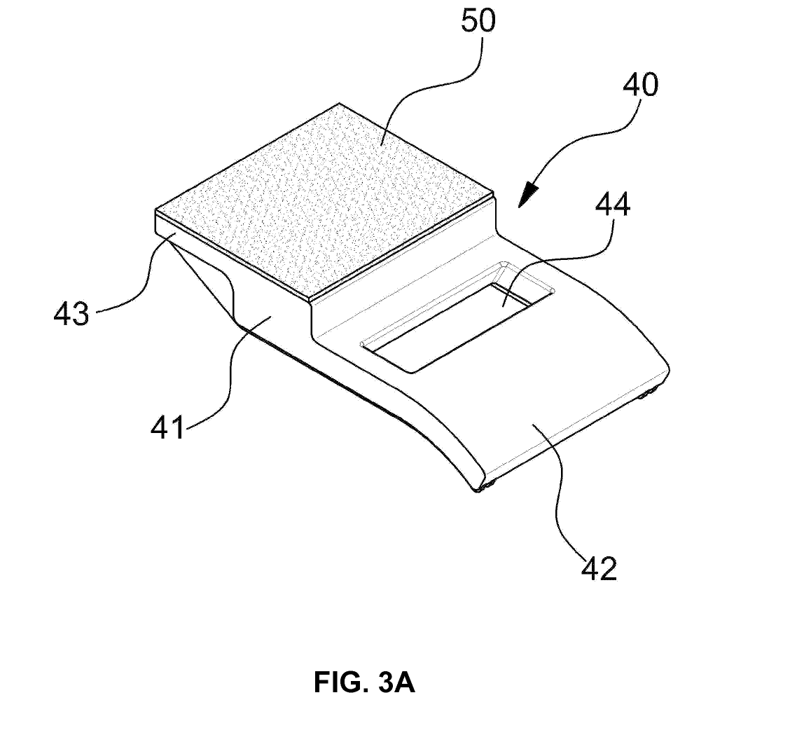

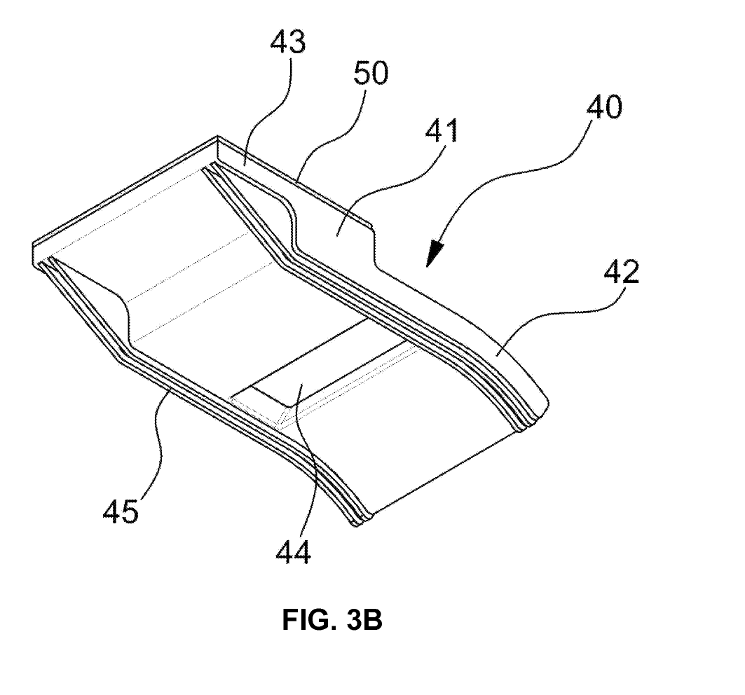

The attached FIG. 2 is a cross-sectional view illustrating a matching structure between the windshield glass and the cowl top cover according to various embodiments of the present invention, and FIG. 3A and FIG. 3B are perspective views illustrating a matching bracket structure between the windshield glass and the cowl top cover.

The matching maintaining structure according to various embodiments of the present invention includes a matching bracket 40 which connects the lower end portion of the windshield glass 10 and the stepped portion 32 of the cowl top cover 20, a welding member 50 which joins the matching bracket 40 to the windshield glass 10, and a hook portion 24 which is formed on the cowl top cover 20 so as to be coupled to the matching bracket 40.

According to the present invention, the matching bracket 40 may be made of steel or plastic, and may include a body portion 41, an elastic plate 42 which is formed integrally with a lower end at one side of the body portion 41, and extended at a predetermined length while being perpendicular to the body portion 41, a fixed plate 43 which is formed integrally with an upper end at the other side of the body portion 41, extended at a predetermined length while being perpendicular to the body portion 41, and disposed in the opposite direction to the elastic plate 42, and a locking hole 44 which penetrates the elastic plate 42, and into which the hook portion 24 of the cowl top cover 20 is locked and fastened.

In this case, the elastic plate 42 may be spread at a predetermined angle, and has elastic restoring force that allows the elastic plate 42 to return to the original position after the elastic plate 42 has been spread.

In addition, an outer surface of the fixed plate 43 in addition to an outer surface of the body portion 41 are a portion which is in close contact with and joined to a bottom surface of the windshield glass 10.

In addition, the hook portion 24 is locked to and inserted into the locking hole 44 formed in the elastic plate 42 of the matching bracket 40, and is formed integrally with an end portion of the stepped portion 32 of the cowl top cover 20.

Therefore, an outer surface of the welding member 50 is joined to an inner surface of the windshield glass 10 in a state in which an inner surface of the welding member 50 is attached to outer surfaces of the body portion 41 and the fixed plate 42, such that the matching bracket 40 and the windshield glass 10 are coupled.

In addition, the hook portion 24 enters toward an inner surface of the elastic plate 42, and is simultaneously inserted into the locking hole 44 of the elastic plate 42 so as to be locked and fastened, such that the matching bracket 40 and the cowl top cover 20 are coupled.

Meanwhile, two or more rows of rigidity reinforcing ribs 45 are integrally formed on a back surface of the matching bracket 40, that is, a back surface of the elastic plate 42, such that rigidity may be maintained even when the elastic plate 42 is spread.

As described above, when the windshield glass 10 and the cowl top cover 20 are matched, the lower end portion of the windshield glass 10 and the stepped portion 32 of the cowl top cover 20 are connected to each other using the matching bracket 40, such that the windshield glass 10 and the cowl top cover 20 are connected to each other as a single body using the matching bracket 40, and the windshield glass 10 and the cowl top cover 20 inevitably float together, even though one of the windshield glass 10 and the cowl top cover 20 floats when the windshield glass 10 and the cowl top cover 20 are assembled, thereby preventing a matching stepped portion from being formed between the windshield glass and the cowl top cover, and maintaining accurate mutual matching property.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for assembling a windshield glass and a cowl top cover for a vehicle, comprising:
a strip disposed between the windshield glass and the cowl top cover; and
a matching maintaining device disposed at bottom portions of the windshield glass and the cowl top cover, binding a lower end portion of the windshield glass and a stepped portion of the cowl top cover together, and allowing the windshield glass and the cowl top cover to float at the same time.

2. The apparatus of claim 1, wherein the matching maintaining device includes:
a matching bracket having a body portion, an elastic plate formed integrally with a lower end at one side of the body portion and having a locking hole that penetrates the elastic plate, and a fixed plate formed integrally with an upper end at another side of the body portion, and disposed to be extended in an opposite direction to the elastic plate;
a hook portion formed integrally with an end of the stepped portion of the cowl top cover, and locked and fastened to the locking hole of the elastic plate; and
a welding member attached to outer surfaces of the body portion and the fixed plate, and coupled to an inner surface of the windshield glass.

3. The apparatus of claim 1, wherein two or more rows of rigidity reinforcing ribs are integrally formed on a back surface of the matching bracket.
